(19) United States
(12) Patent Application Publication
(10) Pub. No.: US 2025/0284548 A1
(43) Pub. Date: Sep. 11, 2025

(54) CONTROL DEVICE, RESOURCE MANAGEMENT METHOD AND STORAGE MEDIUM THEREOF

(71) Applicant: DENSO CORPORATION, Kariya-city (JP)

(72) Inventors: AKIHIRO SHIBATA, Kariya-city (JP); KOJI HAYASHI, Kariya-city (JP)

(21) Appl. No.: 19/217,643

(22) Filed: May 23, 2025

Related U.S. Application Data
(63) Continuation of application No. PCT/JP2023/037570, filed on Oct. 17, 2023.

(30) Foreign Application Priority Data
Nov. 28, 2022 (JP) 2022-189434

(51) Int. Cl. G06F 9/50

(52) U.S. Cl. CPC G06F 9/5027

(57) ABSTRACT

A control device controls multiple containers to share a hardware resource and a host operating system, and includes: an automated driving container executing an automated driving application on the host operating system, the automated driving application executing an automated driving process of a vehicle; a user container executing a user application on the host operating system, the user application being designated by a user; and a container management layer managing an allocation of the hardware resource to the automated driving application and the user application. In response to determining that a low workload condition, in which a workload of the automated driving application decreases to a set range, being satisfied, the container management layer allocates, to the user application, a remainder of the hardware resource, which is required for continuing an execution of the automated driving application.

### CROSS REFERENCE TO RELATED APPLICATIONS

The present application is a continuation application of International Patent Application No. PCT/2023/037570 filed on Oct. 17, 2023, which designated the U.S. and claims the benefit of priority from Japanese Patent Application No. 2022-189434 filed on Nov. 28, 2022. The entire disclosures of all of the above applications are incorporated herein by reference.

### TECHNICAL FIELD

The present disclosure relates to a containerized virtualization technology that enables multiple containers to share a hardware resource and a host operating system.

### BACKGROUND

In conventional containerized virtualization technology, a control device includes high-performance hardware to execute an automated driving process that requires a large amount of computation resource.

### SUMMARY

According to an aspect of the present disclosure, a control device controls multiple containers to share a hardware resource and a host operating system. The control device includes an automated driving container, a user container, and a container management layer. The automated driving container executes an automated driving application on the host operating system. The automated driving application executes an automated driving process of a vehicle. The user container executes a user application on the host operating system. The user application is designated by a user. The container management layer manages an allocation of the hardware resource to the automated driving application and the user application. In response to determining that a low workload condition, in which a workload of the automated driving application decreases to a set range, being satisfied, the container management layer allocates, to the user application, a remainder of the hardware resource, which is required for continuing an execution of the automated driving application.

### BRIEF DESCRIPTION OF DRAWINGS

Features of the present disclosure will become apparent from the following detailed description made with reference to the accompanying drawings. In the drawings:

FIG. 1 is a schematic diagram showing a vehicle equipped with a control device according to a first embodiment of the present disclosure;

FIG. 2 is a schematic diagram showing a control device according to the first embodiment of the present disclosure;

FIG. 3 is a flowchart showing a resource management flow according to the first embodiment of the present disclosure;

FIG. 4 is a schematic diagram showing a control device according to a second embodiment of the present disclosure;

FIG. 5 is a flowchart showing a resource management flow according to the second embodiment of the present disclosure;

FIG. 6 is a schematic diagram showing a control device according to a third embodiment of the present disclosure;

FIG. 7 is a flowchart showing a resource management flow according to the third embodiment of the present disclosure;

FIG. 8 is a schematic diagram showing a control device according to a fourth embodiment of the present disclosure;

FIG. 9 is a flowchart showing a resource management flow according to the fourth embodiment of the present disclosure;

FIG. 10 is a schematic diagram showing a control device according to a fifth embodiment of the present disclosure;

FIG. 11 is a flowchart showing a resource management flow according to the fifth embodiment of the present disclosure;

FIG. 12 is a schematic diagram showing a control device according to a sixth embodiment of the present disclosure;

FIG. 13 is a flowchart showing a resource management flow according to the sixth embodiment of the present disclosure;

FIG. 14 is a schematic diagram showing a control device according to a seventh embodiment of the present disclosure;

FIG. 15 is a flowchart showing a resource management flow according to the seventh embodiment of the present disclosure;

FIG. 16 is a schematic diagram showing a control device according to an eighth embodiment of the present disclosure;

FIG. 17 is a flowchart showing a resource management flow according to the eighth embodiment of the present disclosure;

FIG. 18 is a schematic diagram showing a control device according to a ninth embodiment of the present disclosure;

FIG. 19 is a flowchart showing a resource management flow according to the ninth embodiment of the present disclosure;

FIG. 20 is a schematic diagram showing a control device according to a tenth embodiment of the present disclosure;

FIG. 21 is a flowchart showing a resource management flow according to the tenth embodiment of the present disclosure;

FIG. 22 is a schematic diagram showing a control device according to a modification example of the second embodiment; and

FIG. 23 is a flowchart showing a resource management flow according to the modification example of the second embodiment.

### DETAILED DESCRIPTION

Usually, in a control device, high-performance hardware resource for executing an automated driving process of a vehicle is statically allocated to an automated driving application. Hereinafter, automated driving may be abbreviated as AD. When the automated driving application is not in the execution state and thus the workload is low, an idle time may occur in the hardware resource. The idle time may refer to a period of time during which a computer, processor, or system is powered on and operational but not actively engaged in processing any tasks or data.

According to a first aspect of the present disclosure, a control device, which controls multiple containers to share a hardware resource and a host operating system. The control device includes an automated driving container, a user container, and a container management layer. The automated driving container executes an automated driving application on the host operating system. The automated driving application executes an automated driving process of a vehicle. The user container executes a user application on the host operating system. The user application is designated by a user. The container management layer manages an allocation of the hardware resource to the automated driving application and the user application. In response to determining that a low workload condition, in which a workload of the automated driving application decreases to a set range, being satisfied, the container management layer allocates, to the user application, a remainder of the hardware resource, which is required for continuing an execution of the automated driving application.

According to a second aspect of the present disclosure, a resource management method is executed by a processor for controlling multiple containers to share a hardware resource and a host operating system. The resource management method includes: executing an automated driving application on the host operating system, the automated driving application executing an automated driving process of a vehicle; executing a user application, which is designated by a user, on the host operating system; managing an allocation of the hardware resource to the automated driving application and the user application; determining whether a low workload condition, in which a workload of the automated driving application decreases to a set range, is satisfied; and in response to determining the low workload condition being satisfied, allocating, to the user application, a remainder of the hardware resource, which is required for continuing an execution of the automated driving application.

According to a third aspect of the present disclosure, a computer-readable non-transitory storage medium stores a resource management program. The resource management program includes instructions to be executed by at least one processor for controlling multiple containers to share a hardware resource and a host operating system. The instructions of the resource management program includes: executing an automated driving application on the host operating system, the automated driving application executing an automated driving process of a vehicle; executing a user application, which is designated by a user, on the host operating system; managing an allocation of the hardware resource to the automated driving application and the user application; determining whether a low workload condition, in which a workload of the automated driving application decreases to a set range, is satisfied; and in response to determining the low workload condition being satisfied, allocating, to the user application, a remainder of the hardware resource, which is required for continuing an execution of the automated driving application.

According to the first to third aspects of the present disclosure, when the low workload condition, in which the workload of automated driving application that executes the automated driving process decreases to the set range, is determined to be satisfied, a remainder of the hardware resource, which is required to continue an execution of the automated driving application, is allocated to the user application. In this configuration, when the workload of automated driving application decreases, a part of the hardware resource, is released and the released hardware resource can be allocated to the user application, which is designated by the user and is independent of the automated driving process. Therefore, it is possible to effectively utilize the high-performance hardware resource, which is secured for execution of the automated driving process.

Hereinafter, embodiments of the present disclosure will be described with reference to the drawings. It should be noted that the same reference symbols are assigned to corresponding components in the respective embodiments, and repeated descriptions may be omitted. When only a part of the configuration is described in one embodiment, the configurations of other embodiments described above can be applied to remaining part of the configuration. Further, not only the combinations of the configurations explicitly shown in the description of the respective embodiments, but also the configurations of the multiple embodiments can be partially combined together even if the configurations are not explicitly shown if there is no difficulty in the combination in particular.

### First Embodiment

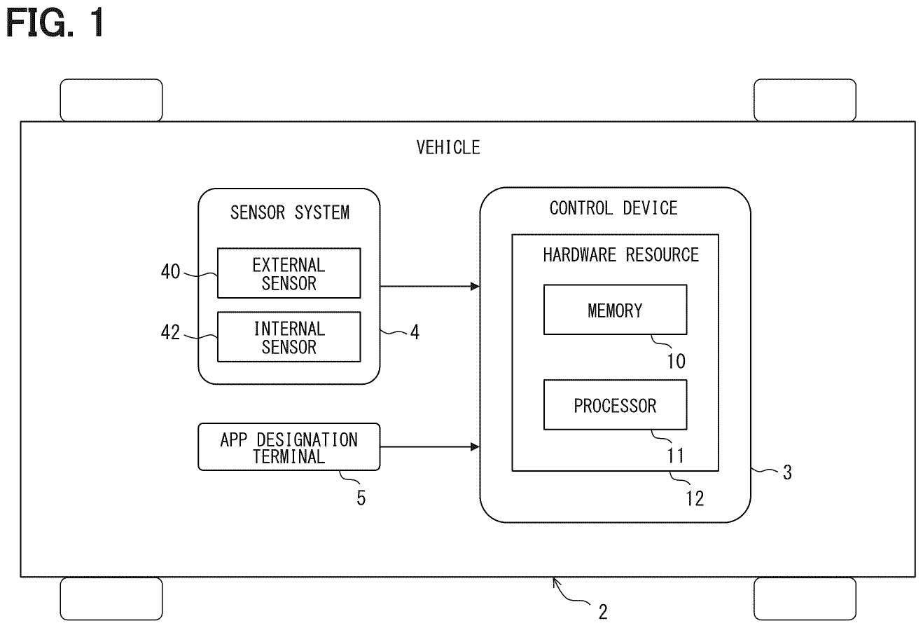

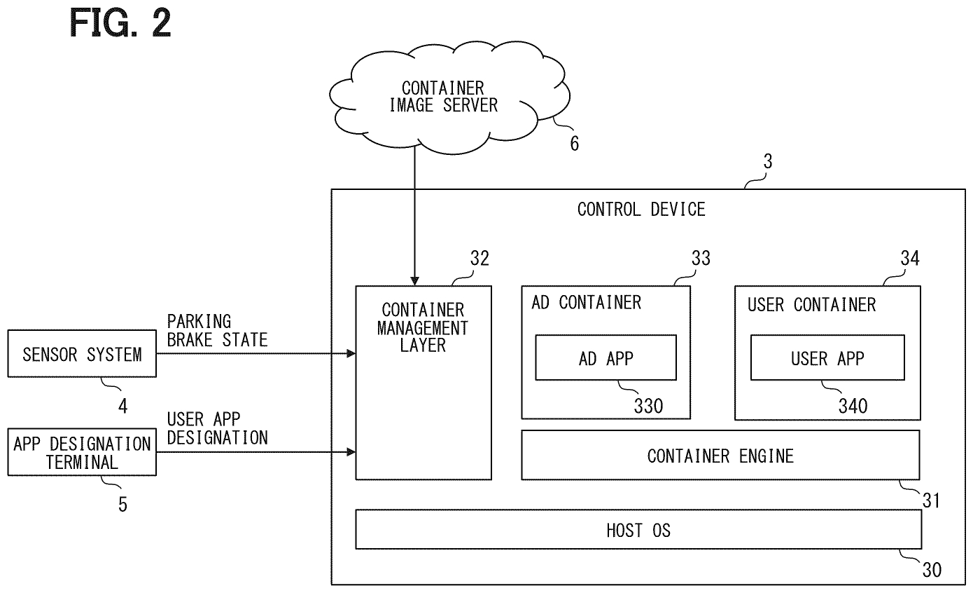

As shown in FIG. 1 and FIG. 2, a control device 3 of the first embodiment allows multiple containers to share a hardware resource 12 and a host operating system 30. Hereinafter, operating system is abbreviated as OS. A vehicle 2 is able to travel in an automated driving mode, and the automated driving mode is classified into multiple levels according to manual intervention level of a driver in a driving task. The automated driving mode may be implemented by an automated driving control, such as conditional driving automation, advanced driving automation, or full driving automation, where the system in operation state performs all driving tasks. The automated driving mode may be implemented by an advanced driving assistance control, such as driving assistance or partial driving automation, where an occupant performs partial or all of the driving tasks. The automated driving mode may be implemented by either one or combination of automated driving control and advanced driving assistance control or switching between the automated control and advanced driving assistance control. The automated driving mode is implemented by a driving control based on the automated driving process to be described below.

As shown in FIG. 1, the vehicle 2 is equipped with a sensor system 4, an application designation terminal 5, and the control device 3. The sensor system 4 acquires sensor information to be used by the control device 3 by detecting an external environment and an internal environment of the vehicle 2. The sensor system 4 includes an external sensor 40 and an internal sensor 42. In FIG. 1 to FIG. 23, for convenience of illustration, application is abbreviated as APP.

The external sensor 40 is configured to acquire, as external environment information, information about external environment of the vehicle 2. The external sensor 40 may acquire the external environment information by detecting objects existing in the external environment of the vehicle 2. The external sensor 40, which detects the objects, may be at least one of a camera, a LIDAR (Light Detection and Ranging/Laser Imaging Detection and Ranging), a radar, sonar, or the like. The external sensor 40 may acquire the external environment information by receiving positioning signals from artificial satellites of GNSS (Global Navigation Satellite System) existing in the external environment of the vehicle 2. The external sensor 40 may be provided by a GNSS receiver or the like, which has a positioning function. The external sensor 40 may acquire external environment information by transmitting and receiving a communication signal to and from a V2X system existing outside the vehicle 2. The external sensor 40 having a communication function may be at least one of a DSRC (Dedicated Short Range Communications) communication device, a cellular V2X (C-V2X) communication device, a Bluetooth (registered trademark) device, a Wi-Fi (registered trademark) device, and an infrared communication device.

The internal sensor 42 is configured to acquire, as internal environment information, information about internal environment of the vehicle 2. The internal sensor 42 may acquire the internal environment information by detecting a specific kinematic physical quantity in the internal environment of the vehicle 2. The internal sensor 42, which has a detection function of physical quantity, may be at least one of a traveling speed sensor, an acceleration sensor, a gyro sensor, or the like. The internal sensor 42 may acquire the internal environment information by detecting a specific state of an occupant in the internal environment of the vehicle 2. The internal sensor 42, which has a detection function of an occupant, may be at least of a driver status monitor (registered trademark), a biological sensor, a seating sensor, an actuator sensor, an in-vehicle device sensor, or the like.

The actuator sensor may detect, as an instruction state of the driver with respect to a driving actuator of the vehicle 2, at least one of an operation state of accelerator pedal, an operation state of brake pedal, an operation state of parking brake, a steering state of steering wheel, an on/off state of start switch, a shift position of vehicle 2, a charging state of vehicle 2, or the like. The in-vehicle device sensor detects, as an instruction state instructed by the driver and another occupant to the in-vehicle device, at least one of an operation state of on/off switch, an operation state of touch panel, or a gesture that can be recognized without contact with the in-vehicle device.

The application designation terminal 5 may be a center display that is able to receive an operation, such as a touch operation made by a user. The application designation terminal 5 displays applications that can be downloaded from an external container image server 6 as shown in FIG. 2. A user who is the occupant of the vehicle 2 can designate an application to be executed by the control device 3 as a user application 340 by selecting an application displayed on the application designation terminal 5.

The container image server 6 stores various container images, for example, a Docker Hub repository. Each container image includes, as a container configuration file, an application, a middleware and a library required to execute the application.

As shown in FIG. 1 and FIG. 2, the control device 3 is connected to the sensor system 4 and the application designation terminal 5 via at least one of, for example, a LAN (Local Area Network) communication line, a wire harness, an internal bus, or a wireless communication line. The control device 3 includes at least one dedicated computer.

The dedicated computer included in the control device 3 may be an integrated electronic control unit (ECU) that integrates driving control of the vehicle 2. The dedicated computer included in the control device 3 may be a determination ECU that determines a driving task in the driving control of the vehicle 2. The dedicated computer included in the control device 3 may be a monitoring ECU that monitors a driving control of the vehicle 2. The dedicated computer included in the control device 3 may be an evaluation ECU that evaluates a driving control of the vehicle 2.

As shown in FIG. 1, the dedicated computer included in the control device 3 has, as a hardware resource 12 of the control device 3, at least one memory 10 and at least one processor 11. The memory 10 is provided by a computer-readable non-transitory tangible storage medium, such as a semiconductor memory, a magnetic medium, or an optical medium, and stores computer-readable program and data. In order to perform an automated driving process, which requires high workload, the processor 11 includes a high-performance core, such as a GPU (Graphics Processing Unit). The processor 11 may further include, as the core, at least one of a central processing unit (CPU), a reduced instruction set computer (RISC)-CPU, a data flow processor (DFP), or a graph streaming processor (GSP).

In addition to a software executed by the processor 11, such as the host OS (Operating System) 30 shown in FIG. 2, container engine 31 shown in FIG. 2, and resource management program (not shown), the memory 10 also stores an automated driving container image and a user container image for constructing the automated driving container 33 and the user container 34, respectively, as shown in FIG. 2. The host OS 30 may be at least one of a real-time OS, Linux (registered trademark), or UNIX (registered trademark).

The processor 11 executes multiple instructions included in a resource management program stored in the memory 10 to control multiple containers to share the hardware resource 12 and the host OS 30. As a result, the control device 3 constructs at least one container management layer 32 for controlling the multiple containers to share the hardware resource 12 and the host OS 30. The control device 3 also constructs an automated driving container 33 and a user container 34 based on the automated driving container image and the user container image, respectively.

The container engine 31 may be implemented by a software, such as Docker, to provide an environment for executing an application of each container. The container engine 31 executes, on the host OS 30, an automated driving application 330 contained in an automated driving container 33, and executes, on the host OS 30, a user application 340 contained in a user container 34.

The automated driving container 33 contains the automated driving application 330 and middleware (not shown). The automated driving application 330 executes an automated driving process of the vehicle 2 based on sensor information acquired by the sensor system 4. The automated driving process executed by the automated driving application 330 includes high workload process, such as external environment recognition process and driving planning process.

The user container 34 shares the host OS 30 and the hardware resource 12 of the control device 3 with the automated driving container 33. The user container 34 includes the user applications 340, which is designated by the user, and the middleware (not shown). The user application 340 may be a high workload application that requires high performance hardware resource 12 when being executed.

The user application 340 may be a machine learning application that updates parameters of a machine learning model related to the automated driving of the vehicle 2. When the user application is a machine learning application, the user application 340 may feedback parameters of the machine learning model to an external center, or may directly update the parameters.

The user application 340 may be a rental application that rents out the hardware resource 12 of the control device 3 to an external device, such as a server. The user application 340, which is a rental application, may rent out the hardware resource 12 as IaaS (Infrastructure as a Service) or PaaS (Platform as a Service), or may rent out the hardware resource 12 for mining virtual currency.

The user application 340 may be used to test and execute pre-release application related to the vehicle 2 in a virtual environment. The user application 340 may be an update application that updates software distributed by OTA (On The Air) from an external source to the vehicle 2. The user application 340 may be a sensing pre-processing application that processes sensor information acquired by the sensor system 4 and uploads the data obtained by the pre-processing to an external device, such as a server.

The user application 340 may be a media application, for example, playing video content such as movies. The user application 340 may be an encoder application that encodes video data and/or audio data. The user application 340 may be an upconversion application that performs upconversion of video data and/or still image data. The user application 340 may be a simulation application that performs, for example, a numerical simulation or new drug developing simulation.

The container management layer 32 manages allocation of the hardware resource 12 to the automated driving application 330 and the user application 340, based on sensor information acquired by the sensor system 4. Specifically, the container management layer 32 determines whether a low workload condition is satisfied. The low workload condition refers to a condition in which the workload of automated driving application 330 decreases to a set range. The set range may be set, in advance, to a range that enables the hardware resource 12 required for the operation of user application 340 to be secured by a remainder of the hardware resource 12. The remainder of the hardware resource 12 refers to the hardware resource that is required for continuing operation of the automated driving application 330 in a normal operation state of the automated driving application. When the low workload condition is determined to be satisfied, the container management layer 32 allocates the remainder of the hardware resource 12 to the user application 340. The remainder of the hardware resource 12 corresponds to the hardware resource 12 required for continuing operation of the automated driving application 330. When the low workload condition is determined to be not satisfied, the container management layer 32 stops allocation of the hardware resource 12 to the user application 340, thereby stopping the execution of user application 340. The low workload condition in the first and second to eighth embodiments to be described below is determined to be satisfied when the vehicle 2 is in a parking mode. In the first embodiment, the low workload condition is determined to be satisfied when a parking brake of the vehicle 2 is activated.

When the user designates the user application 340 by operating the application designation terminal 5, the container management layer 32 checks whether a container image including the user application 340 exists in the memory 10. When the container image including the designated user application 340 does not exist in the memory 10, the container management layer 32 obtains the container image by downloading it from the container image server 6 and constructs the user container 34 based on the obtained container image.

The container management layer 32 prohibits access by the user application 340 to the driving related control of the vehicle 2. As a prohibition to access driving related control, the container management layer 32 may prohibit the user application 340 from accessing the automated driving container 33. As a prohibition to access driving related control, the container management layer 32 may prohibit the user application 340 from accessing any component other than the hardware resource 12.

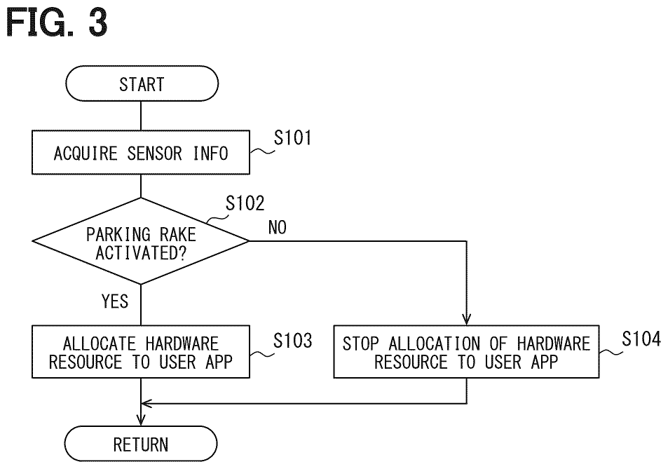

The flow of resource management method performed by the control device 3 will be described with reference to FIG. 3. In this flow, the symbol “S” represents each step executed by corresponding instruction included in the resource management program. The resource management flow is repeatedly executed at predetermined control period of the control device 3.

In S101, the container management layer 32 acquires sensor information from the sensor system 4. In the first embodiment, the container management layer 32 acquires at least an operation state of the parking brake of the vehicle 2, as the sensor information.

In S102, the container management layer 32 determines whether the low workload condition is satisfied based on the sensor information acquired in S101. Specifically, the container management layer 32 determines whether the parking brake is activated or not. In response to determining that the parking brake being activated (S102: YES), the resource management flow proceeds to S103. In response to determining that the parking brake being not activated (S102: NO), the resource management flow proceeds to S104.

When the low workload condition is determined to be satisfied, in S103, the container management layer 32 allocates the remainder of the hardware resource 12 to the user application 340. The remainder of the hardware resource 12 corresponds to the hardware resource 12 required for continuing operation of the automated driving application 330.

When the low workload condition is determined to be not satisfied, in S104, the container management layer 32 stops allocation of the hardware resource 12 to the user application 340.

### Effects and Advantages

The operation effects of the first embodiment will be described below.

In the first embodiment, when the container management layer 32 determines that the low workload condition, in which the workload of automated driving application 330 that executes the automated driving process decreases to the set range, is satisfied, a remainder of the hardware resource 12, which is required to continue an execution of the automated driving application 330, is allocated to the user application 340. In this configuration, when the workload of automated driving application 330 decreases, a part of the hardware resource 12 is released and the released hardware resource 12 can be allocated to the user application 340, which is designated by the user and is independent of the automated driving process. Therefore, it is possible to effectively utilize the high-performance hardware resource 12, which is capable of executing the automated driving process.

In the first embodiment, the low workload condition is determined to be satisfied when the vehicle 2 is in the parking mode. Thus, the hardware resource 12 can be allocated to the user application 340 during the parking mode, in which the workload of automated driving application 330 is decreased. Therefore, it is possible to effectively utilize the high-performance hardware resource 12, which is capable of executing automated driving process, when the workload of the automated driving application 330 is decreased.

In the first embodiment, the low workload condition is determined to be satisfied when the parking brake is activated. According to this configuration, the hardware resource 12 can be allocated to the user application in response to determining that the vehicle 2 has entered the parking mode based on the operation state of the parking brake. Therefore, it is possible to effectively utilize the high-performance hardware resource 12, which is capable of executing the automated driving process, in a timely manner in response to a decrease in the workload of the automated driving application 330.

In the first embodiment, the user application 340 may be a machine learning application that updates parameters of a machine learning model related to driving of the vehicle. In this case, it is possible to effectively utilize the high-performance hardware resource 12, which is capable of executing the automated driving process, when the workload of automated driving application 330 decreases. That is, the parameters of the machine learning model can be updated using the high-performance hardware resource 12.

In the first embodiment, the user application 340 may be a rental application that rents out the hardware resource 12 of the control device 3 to an external party. In this case, it is possible to effectively utilize the high-performance hardware resource 12, which is capable of executing automated driving process, when the workload of automated driving application 330 decreases. That is, the computational load of external server can be reduced by performing computation using the high-performance hardware resource.

In the first embodiment, the user application 340 may be a test application that executes a pre-release application in a virtual environment. In this case, it is possible to effectively utilize the high-performance hardware resource 12, which is capable of executing automated driving process, when the workload of automated driving application 330 decreases. That is, execution test can be performed to the pre-release application before it is officially put into operation by using the high-performance hardware resource.

In the first embodiment, the container management layer 32 may prohibit the user application 340 from accessing the automated driving container 33. In this case, an adverse effect caused by the operation of the user application 340 on the automated driving process can be suppressed. Therefore, it is possible to improve a safety of the vehicle 2 by effectively utilizing the high-performance hardware resource 12, which is capable of executing the automated driving process.

In the first embodiment, the container management layer 32 may prohibit the user application 340 from accessing a component other than the hardware resource 12. In this case, an adverse influence caused by the operation of the user application 340 on the vehicle driving operation can be suppressed. Therefore, it is possible to utilize, with improved safety and efficiency, the high-performance hardware resource 12, which is capable of executing the automated driving process.

In the first embodiment, the container management layer 32 stops allocation of the hardware resource 12 to the user application 340 when the low workload condition is determined to be not satisfied. With this configuration, the hardware resource 12 can be properly allocated to the automated driving process when the workload of the automated driving application 330 does not decrease. Therefore, it is possible to improve a safety of the vehicle 2 by effectively utilizing the high-performance hardware resource 12, which is capable of executing the automated driving process.

### Second Embodiment

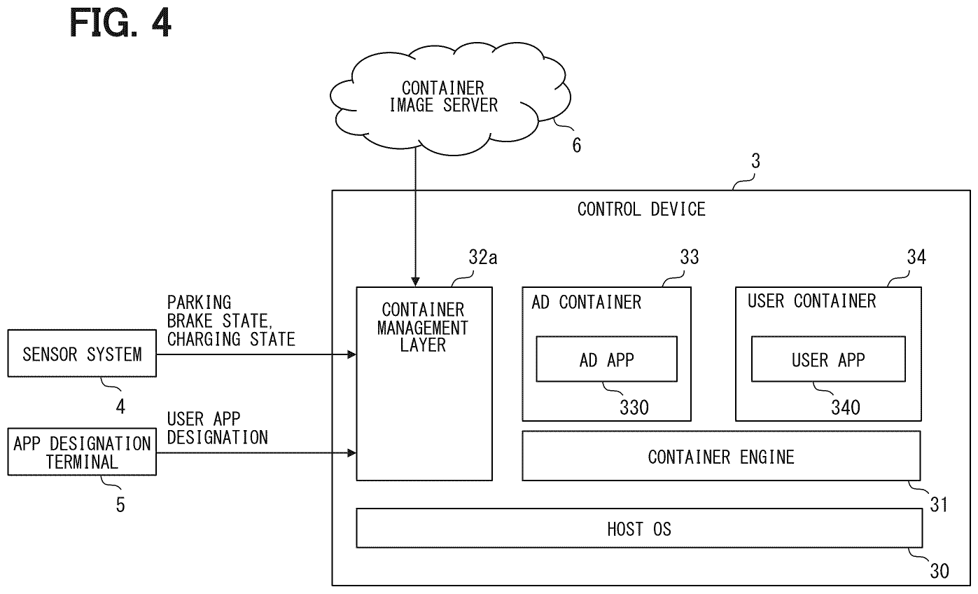

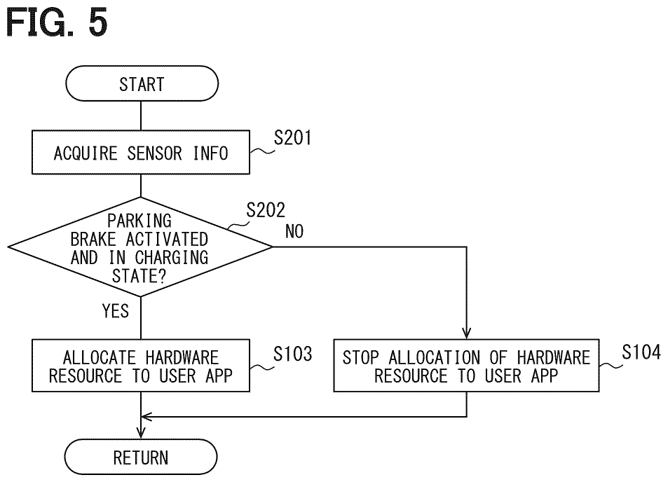

The second embodiment shown in FIG. 4 and FIG. 5 is a modification of the first embodiment, and the second embodiment can be implemented when the vehicle 2 has a chargeable power source. In the second embodiment, the satisfaction of low workload condition in which the workload of the automated driving application 330 decrease to a set range is set to be different from the low workload condition in the first embodiment.

The low workload condition in the second embodiment is determined to be satisfied when the parking brake of the vehicle 2 is activated and the vehicle 2 is in an electric power charging state. When the low workload condition is determined to be satisfied, the container management layer 32a allocates the remainder of the hardware resource 12 to the user application 340. The remainder of the hardware resource 12 corresponds to the hardware resource 12 required for continuing the operation of automated driving application 330.

The following will describe a resource management flow executed by the control device 3 of the second embodiment with reference to the flowchart of FIG. 5. The resource management flow is repeatedly executed at predetermined control period of the control device 3.

In S201, which is executed instead of S101 in the resource management flow of the first embodiment, the container management layer 32a acquires, from the sensor system 4, at least the operation state of parking brake of the vehicle 2 and a charging state of the vehicle 2, as the sensor information.

In S202, which is executed instead of S102 in the resource management flow of the first embodiment, the container management layer 32a determines whether the low workload condition is satisfied based on the sensor information acquired in S201. The container management layer 32a determines whether the parking brake of the vehicle 2 is activated and whether the vehicle 2 is in charging state. In response to affirmative determination is made in S202, the resource management flow proceeds to S103. In response to a negative determination is made in S202, the resource management flow proceeds to S104.

As described above, according to the second embodiment, the low workload condition is determined to be satisfied when the parking brake is activated and the vehicle 2 is in charging state. According to this configuration, the hardware resource 12 can be allocated to the user application in response to determining that the vehicle 2 has entered the parking mode based not only on the operation state of the parking brake, but also on the charging state of the vehicle 2. Therefore, it is possible to effectively utilize the high-performance hardware resource 12, which is capable of executing the automated driving process, in a timely manner in response to a decrease in the workload of the automated driving application 330.

### Third Embodiment

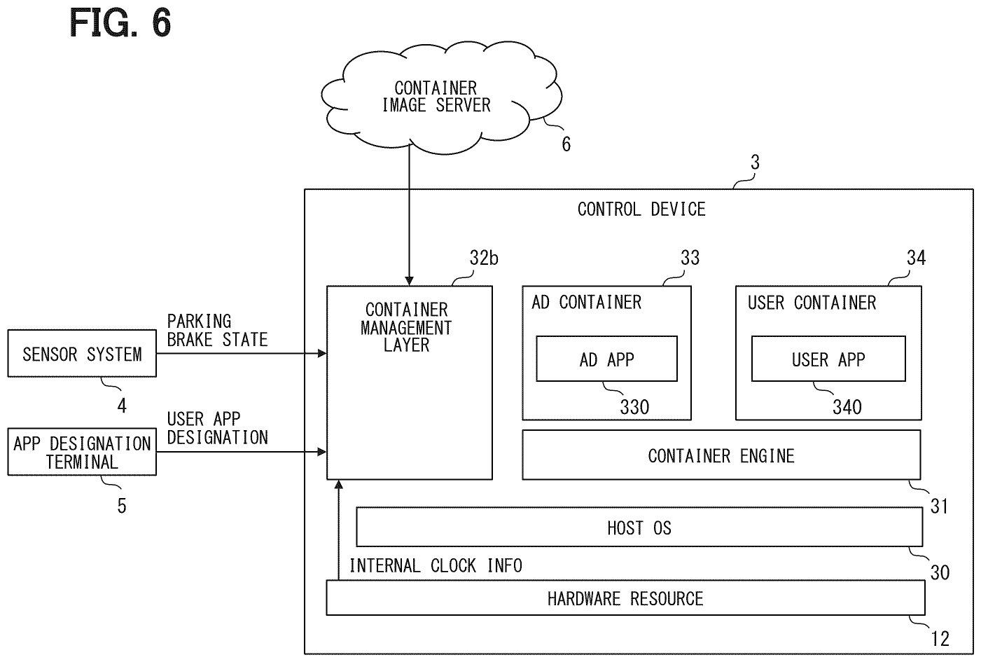

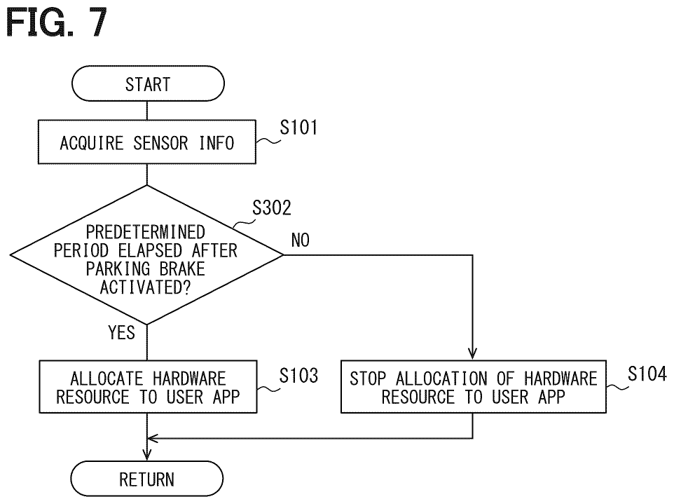

The third embodiment shown in FIG. 6 and FIG. 7 is a modification of the first embodiment. In the third embodiment, the satisfaction of low workload condition in which the workload of the automated driving application 330 decrease to a set range is set to be different from the low workload condition in the first embodiment.

The low workload condition in the third embodiment is determined to be satisfied when a predetermined period of time has elapsed from the parking brake of the vehicle 2 was activated. When the low workload condition is determined to be satisfied, the container management layer 32b allocates the remainder of the hardware resource 12 to the user application 340. The remainder of the hardware resource 12 corresponds to the hardware resource 12 required for continuing the operation of automated driving application 330.

The following will describe a resource management flow executed by the control device 3 of the third embodiment with reference to the flowchart of FIG. 7. The resource management flow is repeatedly executed at predetermined control period of the control device 3.

In S302, which is executed after S101 and is executed instead of S102 of the resource management flow of the first embodiment, the container management layer 32b determines whether the low workload condition is satisfied based on the sensor information acquired in S101 and internal clock information of the control device 3. The container management layer 32b determines whether a predetermined period of time has elapsed from the parking brake of the vehicle 2 was activated. When an affirmative determination is made in S302, the resource management flow proceeds to S103. When a negative determination is made in S302, the resource management flow proceeds to S104.

In the third embodiment, the low workload condition is determined to be satisfied when a predetermined period of time has elapsed from when the parking brake was activated. According to this configuration, the hardware resource 12 can be allocated to the user application in response to determining that a predetermined period of time has elapsed after the parking brake of the vehicle 2 was activated. Therefore, it is possible to effectively utilize the high-performance hardware resource 12, which is capable of executing the automated driving process, in a timely manner in response to a decrease in the workload of the automated driving application 330.

Incidentally, S302 may be interpreted as whether or not the time during which the workload falls within a set range continues for a set time or more. The low workload condition of the third embodiment is determined to be satisfied when the activated state of the parking brake of the vehicle 2 continues for a set period or longer.

### Fourth Embodiment

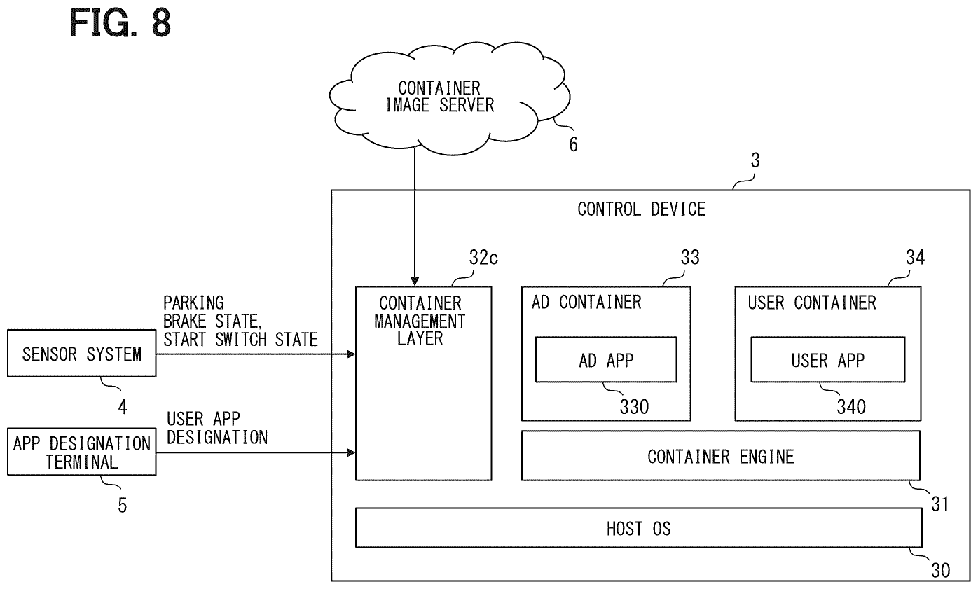

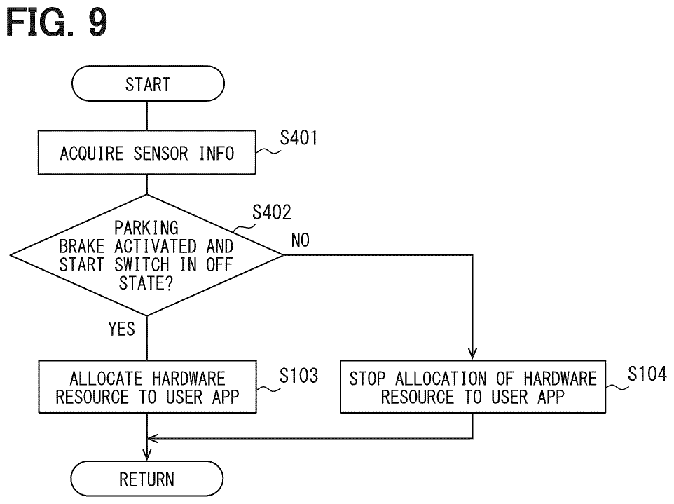

The fourth embodiment shown in FIG. 8 and FIG. 9 is a modification of the first embodiment. In the fourth embodiment, the satisfaction of low workload condition in which the workload of the automated driving application 330 decrease to a set range is set to be different from the low workload condition in the first embodiment.

The low workload condition of the fourth embodiment is determined to be satisfied when the parking brake of the vehicle 2 is activated and the start switch of the vehicle 2 is turned off. When the low workload condition is determined to be satisfied, the container management layer 32c allocates the remainder of the hardware resource 12 to the user application 340. The remainder of the hardware resource 12 corresponds to the hardware resource 12 required for continuing the operation of automated driving application 330.

The following will describe a resource management flow executed by the control device 3 of the fourth embodiment with reference to the flowchart of FIG. 9. The resource management flow is repeatedly executed at predetermined control period of the control device 3.

In S401, which is executed instead of S101 in the resource management flow of the first embodiment, the container management layer 32c acquires, from the sensor system 4, at least the operation state of the parking brake and the on/off state of the start switch as the sensor information.

In S402, which is executed instead of S102 in the resource management flow of the first embodiment, the container management layer 32c determines whether the low workload condition is satisfied based on the sensor information acquired in S401. The container management layer 32c determines whether the parking brake of the vehicle 2 is activated and whether the start switch of the vehicle 2 is turned off. When an affirmative determination is made in S402, the resource management flow proceeds to S103. When a negative determination is made in S402, the resource management flow proceeds to S104.

As described above, according to the fourth embodiment, the low workload condition is determined to be satisfied when the parking brake is activated and the start switch of the vehicle 2 is turned off. According to this configuration, the hardware resource 12 can be allocated to the user application in response to determining that the vehicle 2 has entered the parking mode based not only on the operation state of the parking brake, but also on an operation state of the start switch. Therefore, it is possible to effectively utilize the high-performance hardware resource 12, which is capable of executing the automated driving process, in a timely manner in response to a decrease in the workload of the automated driving application 330.

### Fifth Embodiment

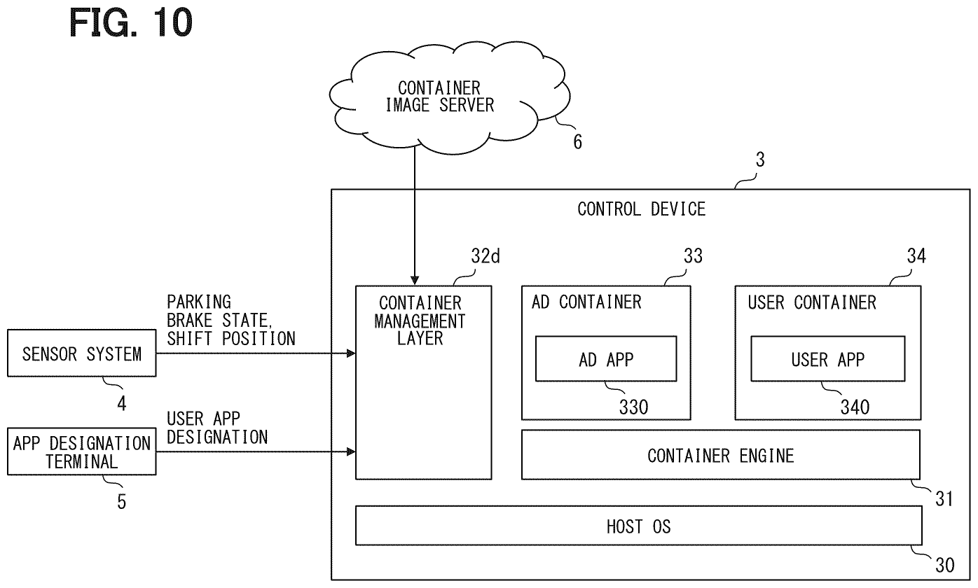

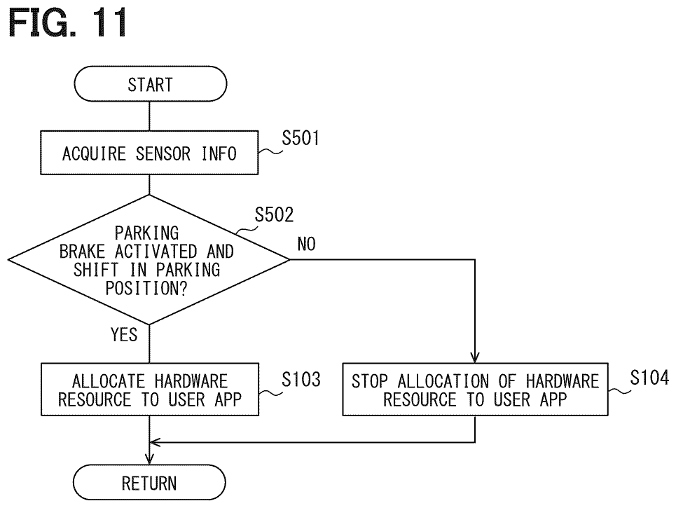

The fifth embodiment shown in FIG. 10 and FIG. 11 is a modification of the first embodiment. In the fifth embodiment, the satisfaction of low workload condition in which the workload of the automated driving application 330 decrease to a set range is set to be different from the low workload condition in the first embodiment.

The low workload condition of the fifth embodiment is determined to be satisfied when the parking brake of the vehicle 2 is activated and a shift position of the vehicle 2 is set to the parking position. When the low workload condition is determined to be satisfied, the container management layer 32d allocates the remainder of the hardware resource 12 to the user application 340. The remainder of the hardware resource 12 corresponds to the hardware resource 12 required for continuing the operation of automated driving application 330.

The following will describe a resource management flow executed by the control device 3 of the fifth embodiment with reference to the flowchart of FIG. 11. The resource management flow is repeatedly executed at predetermined control period of the control device 3.

In S501, which is executed instead of S101 in the resource management flow of the first embodiment, the container management layer 32d acquires, from the sensor system 4, at least the operation state of the parking brake and a shift position of the vehicle, as the sensor information.

In S502, which is executed instead of S102 in the resource management flow of the first embodiment, the container management layer 32d determines whether the low workload condition is satisfied based on the sensor information acquired in S501. The container management layer 32d determines whether the parking brake of the vehicle 2 is activated and whether the shift position of the vehicle 2 is in the parking position. When an affirmative determination is made in S502, the resource management flow proceeds to S103. When a negative determination is made in S502, the resource management flow proceeds to S104.

As described above, the low workload condition of the fifth embodiment is determined to be satisfied when the parking brake of the vehicle 2 is activated and the shift position of the vehicle 2 is set to the parking position. According to this configuration, the hardware resource 12 can be allocated to the user application in response to determining that the vehicle 2 has entered the parking mode based not only on the operation state of the parking brake, but also on the shift position of the vehicle 2. Therefore, it is possible to effectively utilize the high-performance hardware resource 12, which is capable of executing the automated driving process, in a timely manner in response to a decrease in the workload of the automated driving application 330.

### Sixth Embodiment

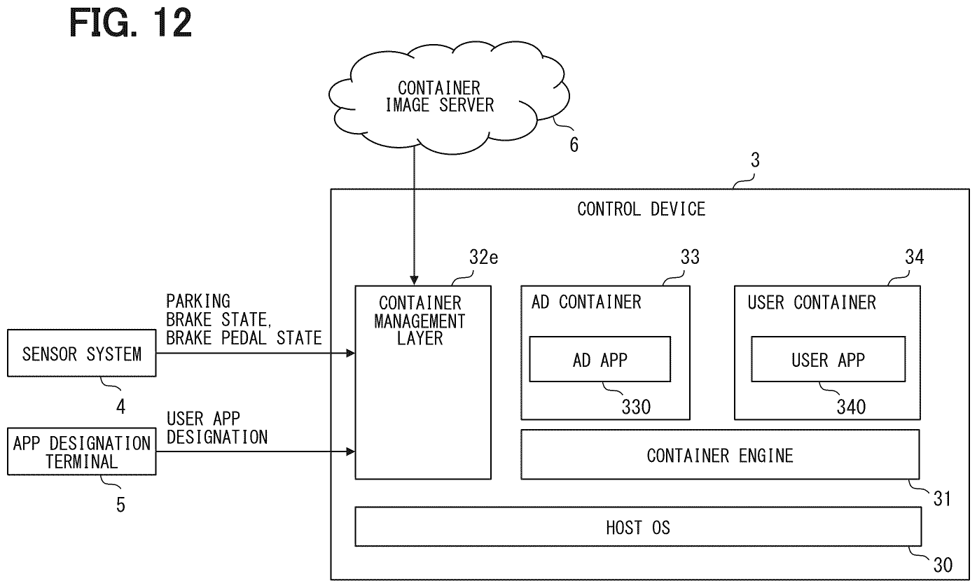

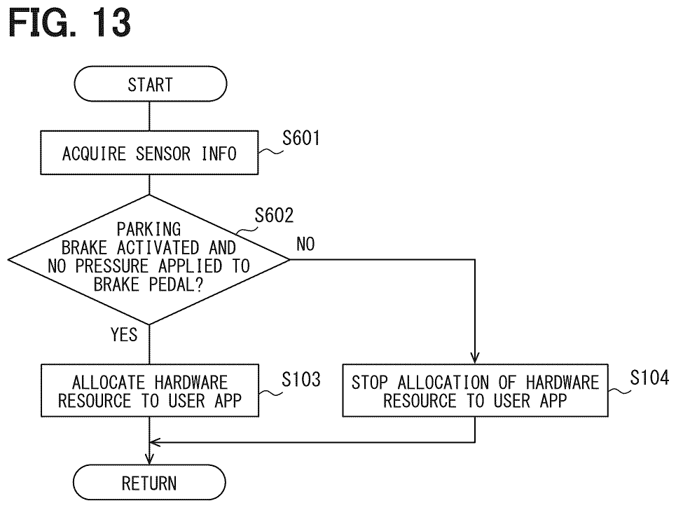

The sixth embodiment shown in FIG. 12 and FIG. 13 is a modification of the first embodiment. In the sixth embodiment, the satisfaction of low workload condition in which the workload of the automated driving application 330 decrease to a set range is set to be different from the low workload condition in the first embodiment.

The low workload condition of the sixth embodiment is determined to be satisfied when the parking brake of the vehicle 2 is activated and the no pressure is applied to a brake pedal of the vehicle 2. When the low workload condition is determined to be satisfied, the container management layer 32e allocates the remainder of the hardware resource 12 to the user application 340. The remainder of the hardware resource 12 corresponds to the hardware resource 12 required for continuing the operation of automated driving application 330.

The following will describe a resource management flow executed by the control device 3 of the sixth embodiment with reference to the flowchart of FIG. 13. The resource management flow is repeatedly executed at predetermined control period of the control device 3.

In S601, which is executed instead of S101 in the resource management flow of the first embodiment, the container management layer 32e acquires, from the sensor system 4, at least the operation state of the parking brake and an operation state of the brake pedal, as the sensor information.

In S602, which is executed instead of S102 in the resource management flow of the first embodiment, the container management layer 32e determines whether the low workload condition is satisfied based on the sensor information acquired in S601. The container management layer 32e determines whether the parking brake of the vehicle 2 is activated and whether a pressure is applied to the brake pedal of the vehicle. In S602, in response to determining that the parking brake of the vehicle 2 is activated and no pressure is applied to the brake pedal of the vehicle 2, the resource management flow proceeds to S103. In S602, in response to determining that the parking brake of the vehicle 2 is not activated or a pressure is applied to the brake pedal of the vehicle 2, the resource management flow proceeds to S104.

The low workload condition of the sixth embodiment is determined to be satisfied when the parking brake of the vehicle 2 is activated and no pressure is applied to a brake pedal of the vehicle 2. According to this configuration, the hardware resource 12 can be allocated to the user application in response to determining that the vehicle 2 has entered the parking mode based not only on the operation state of the parking brake, but also on an operation state of the brake pedal. Therefore, it is possible to effectively utilize the high-performance hardware resource 12, which is capable of executing the automated driving process, in a timely manner in response to a decrease in the workload of the automated driving application 330.

### Seventh Embodiment

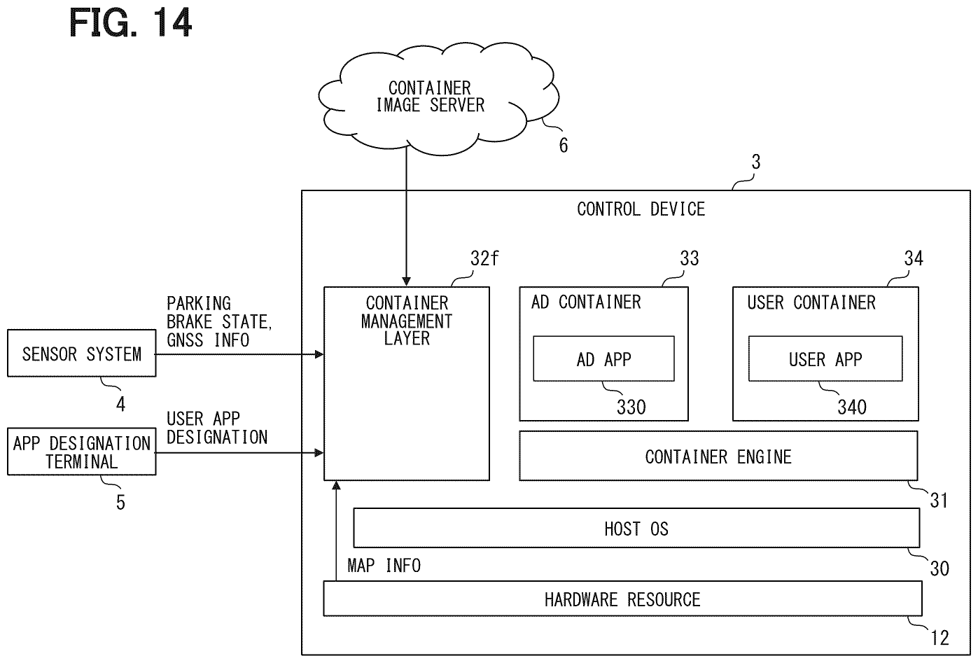

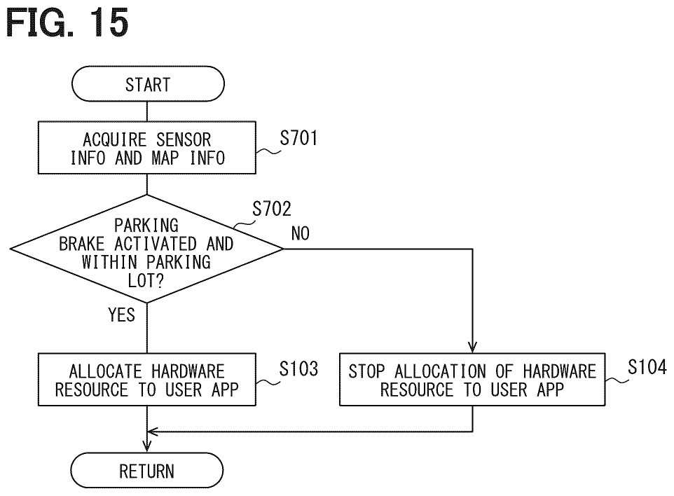

The seventh embodiment shown in FIG. 14 and FIG. 15 is a modification of the first embodiment. In the seventh embodiment, the satisfaction of low workload condition in which the workload of the automated driving application 330 decrease to a set range is set to be different from the low workload condition in the first embodiment.

The low workload condition of the seventh embodiment is determined to be satisfied when the parking brake of the vehicle 2 is activated and a current position of the vehicle 2 is within a parking lot. The current position of the vehicle 2 can be recognized based on GNSS information acquired from the sensor system 4 and map information stored in the memory 10. When the low workload condition is determined to be satisfied, the container management layer 32f allocates the remainder of the hardware resource 12 to the user application 340. The remainder of the hardware resource 12 corresponds to the hardware resource 12 required for continuing the operation of automated driving application 330.

The following will describe a resource management flow executed by the control device 3 of the seventh embodiment with reference to the flowchart of FIG. 15. The resource management flow is repeatedly executed at predetermined control period of the control device 3.

In S701, which is executed instead of S101 in the resource management flow of the first embodiment, the container management layer 32f acquires, from the sensor system 4, at least the operation state of the parking brake and the GNSS information, as the sensor information. In S701, the container management layer 32f may further acquires map information from the memory 10 of the hardware resource 12.

In S702, which is executed instead of S102 in the resource management flow of the first embodiment, the container management layer 32f determines whether the low workload condition is satisfied based on the sensor information and map information acquired in S701. The container management layer 32f determines whether the parking brake of the vehicle 2 is activated and whether the current position of the vehicle 2 is within a parking lot. When an affirmative determination is made in S702, the resource management flow proceeds to S103. When a negative determination is made in S702, the resource management flow proceeds to S104.

In S701, the container management layer 32f may acquire the operation state of parking brake as sensor information, and may acquire the current position of the vehicle 2 from a locator (not shown). In this case, in S702, the container management layer 32f may determine whether the low workload condition is satisfied based on the sensor information acquired from the sensor system 4 and the current position of the vehicle acquired from the locator.

In S701, the container management layer 32f may acquire the operation state of parking brake as sensor information, and may acquire the current position of the vehicle 2, as a processing result of automated driving, from the automated driving container 33. In this case, in S702, the container management layer 32f may determine whether the low workload condition is satisfied based on the sensor information acquired from the sensor system 4 and the current position of the vehicle acquired from the automated driving container 33.

The low workload condition of the seventh embodiment is determined to be satisfied when the parking brake of the vehicle 2 is activated and the current position of the vehicle 2 is within a parking lot. According to this configuration, the hardware resource 12 can be allocated to the user application in response to determining that the vehicle 2 has entered the parking mode based not only on the operation state of the parking brake, but also on the current position of the vehicle 2. Therefore, it is possible to effectively utilize the high-performance hardware resource 12, which is capable of executing the automated driving process, in a timely manner in response to a decrease in the workload of the automated driving application 330.

### Eighth Embodiment

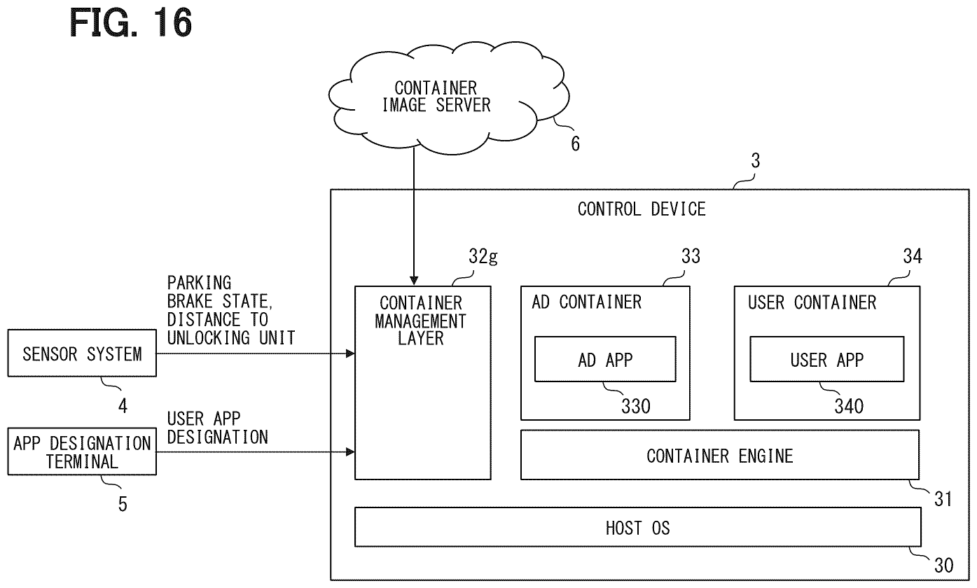

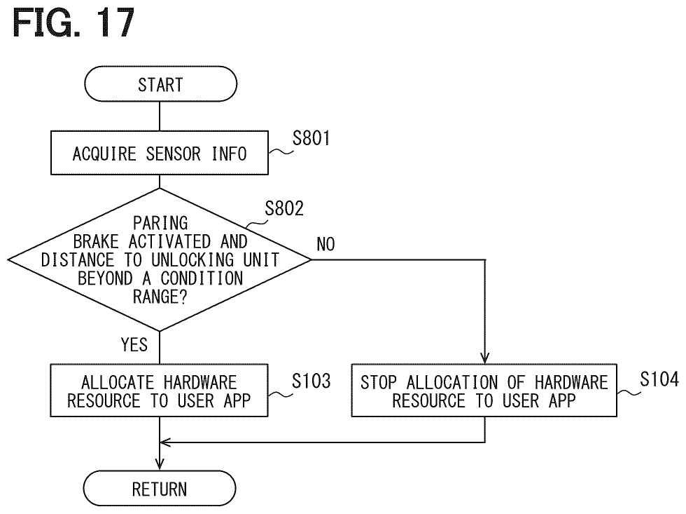

The eighth embodiment shown in FIG. 16 and FIG. 17 is a modification of the first embodiment. In the eighth embodiment, the satisfaction of low workload condition in which the workload of the automated driving application 330 decrease to a set range is set to be different from the low workload condition in the first embodiment.

In the eighth embodiment, the low workload condition is determined to be satisfied when the parking brake of the vehicle 2 is activated and a distance between an unlocking unit, which unlocks the vehicle 2, and the vehicle 2 increases beyond a predetermined condition range. The unlocking unit may be implemented by an IC (Integrated circuit) key or an electronic key, such as a mobile terminal. The unlocking unit can unlock the vehicle 2 and communicate with the sensor system 4 of the vehicle 2. The distance between the unlocking unit and the vehicle 2 is determined based on sensor information from the external sensor 40, which has a communication function and is included in the sensor system 4. Therefore, the condition range of the distance between the unlocking unit and the vehicle may be set within a range of a few meters to a few tens of meters. The condition range of distance is set to determine whether the user carrying the unlocking unit has moved far away from the vehicle 2 by a predetermined distance. When the low workload condition, which includes the distance between the vehicle and the unlocking unit, is determined to be satisfied, the container management layer 32g allocates the remainder of the hardware resource 12 to the user application 340. The remainder of the hardware resource 12 corresponds to the hardware resource 12 required for continuing the operation of automated driving application 330.

The following will describe a resource management flow executed by the control device 3 of the eighth embodiment with reference to the flowchart of FIG. 17. The resource management flow is repeatedly executed at predetermined control period of the control device 3.

In S801, which is executed instead of S101 in the resource management flow of the first embodiment, the container management layer 32g acquires, from the sensor system 4, at least the operation state of the parking brake and the distance between the unlocking unit and the vehicle 2, as the sensor information.

In S802, which is executed instead of S102 in the resource management flow of the first embodiment, the container management layer 32g determines whether the low workload condition is satisfied based on the sensor information acquired in S801. When the container management layer 32g determines whether the parking brake of the vehicle 2 is activated and a distance between the unlocking unit and the vehicle 2 is increased beyond the condition range. When an affirmative determination is made in S802, the resource management flow proceeds to S103. When a negative determination is made in S802, the resource management flow proceeds to S104.

In the eighth embodiment, the low workload condition is determined to be satisfied when the parking brake of the vehicle 2 is activated and the distance between an unlocking unit, which unlocks the vehicle 2, and the vehicle 2 increases to a distance beyond the condition range. According to this configuration, the hardware resource 12 can be allocated to the user application in response to determining that the vehicle 2 has entered the parking mode based not only on the operation state of the parking brake, but also on the distance between the unlocking unit and the vehicle 2. Therefore, it is possible to effectively utilize the high-performance hardware resource 12, which is capable of executing the automated driving process, in a timely manner in response to a decrease in the workload of the automated driving application 330.

### Ninth Embodiment

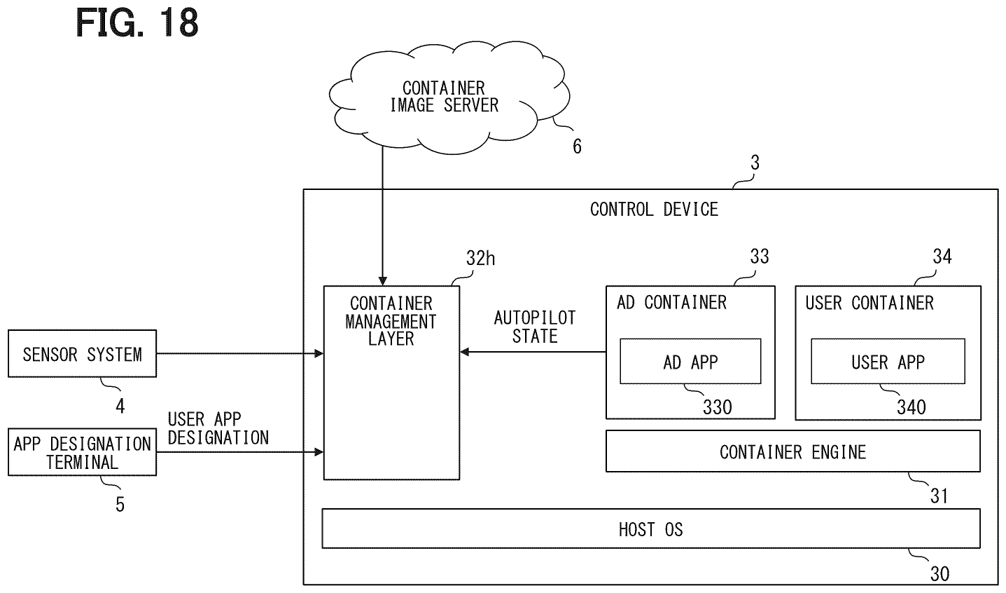

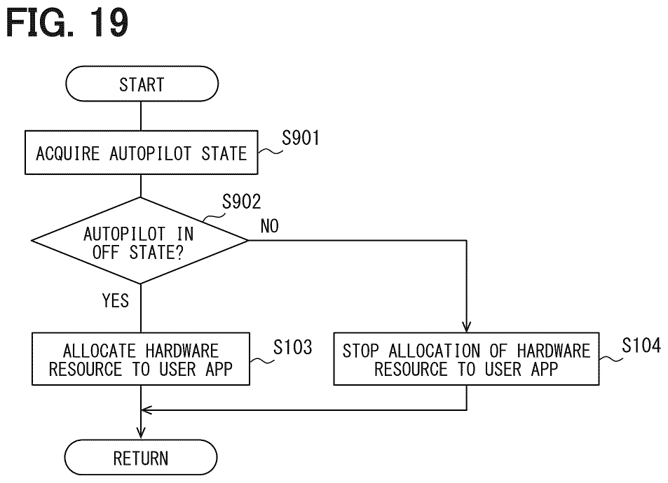

The ninth embodiment shown in FIG. 18 and FIG. 19 is a modification of the first embodiment. In the ninth embodiment, the satisfaction of low workload condition in which the workload of the automated driving application 330 decrease to a set range is set to be different from the low workload condition in the first embodiment.

The low workload condition of the ninth and tenth embodiment to be described below is determined to be satisfied when the vehicle 2 is in the manual driving mode. The manual driving mode refers to a driving mode in which the user performs at least partial driving operation, for example, the automated driving level of 0 to 3 defined by the Society of Automotive Engineers, known as SAE International. The low workload condition of the ninth embodiment is determined to be satisfied when an autopilot function of the vehicle 2 is disabled. The autopilot function is executed by the automated driving process of the automated driving application 330. When the low workload condition is determined to be satisfied, the container management layer 32h allocates the remainder of the hardware resource 12 to the user application 340. The remainder of the hardware resource 12 corresponds to the hardware resource 12 required for continuing the operation of automated driving application 330.

The following will describe a resource management flow executed by the control device 3 of the ninth embodiment with reference to the flowchart of FIG. 19. The resource management flow is repeatedly executed at predetermined control period of the control device 3.

In S901, which is executed instead of S101 in the resource management flow of the first embodiment, the container management layer 32h acquires at least an on/off state of the autopilot function from the automated driving container 33 as a result of the automated driving process.

In S902, which is executed instead of S102 in the resource management flow of the first embodiment, the container management layer 32h determines whether the low workload condition is satisfied based on the operation state of the autopilot function acquired in S901. The container management layer 32h determines whether the autopilot function of the vehicle 2, which is executed by the automated driving process, is in off state. When an affirmative determination is made in S902, the resource management flow proceeds to S103. When a negative determination is made in S902, the resource management flow proceeds to S104.

The low workload condition of the ninth embodiment is determined to be satisfied when the vehicle 2 is in the manual driving mode. Thus, the hardware resource 12 can be allocated to the user application 340 during the manual driving, in which the workload of automated driving application 330 is decreased. Therefore, it is possible to effectively utilize the high-performance hardware resource 12, which is capable of executing automated driving process, when the workload of the automated driving application 330 is decreased.

The low workload condition of the ninth embodiment is determined to be satisfied when the autopilot function of the vehicle 2, which is executed by the automated driving process, is in disabled state. According to this configuration, the hardware resource 12 can be allocated to the user application in response to determining that the vehicle 2 is switched to the manual driving mode based on the operation state of autopilot function. Therefore, it is possible to effectively utilize the high-performance hardware resource 12, which is capable of executing the automated driving process, in a timely manner in response to a decrease in the workload of the automated driving application 330.

### Tenth Embodiment

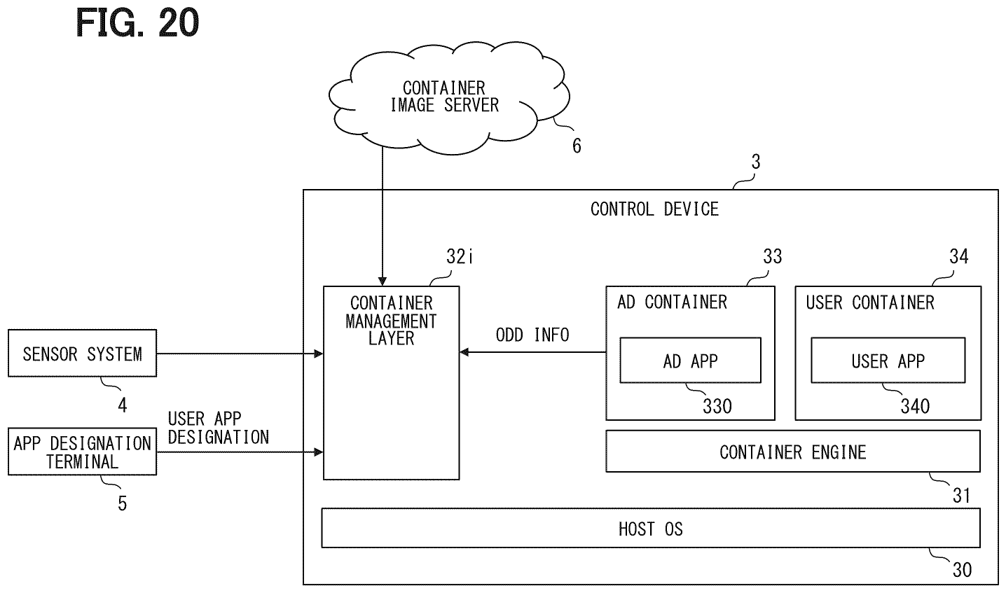

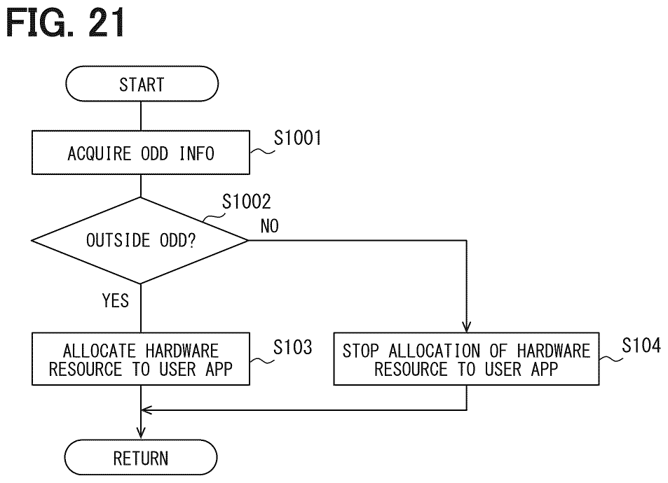

The tenth embodiment shown in FIG. 20 and FIG. 21 is a modification of the ninth embodiment. In the tenth embodiment, the satisfaction of low workload condition in which the workload of the automated driving application 330 decrease to a set range is set to be different from the low workload condition in the ninth embodiment.

The low workload condition of the tenth embodiment is determined to be satisfied when the vehicle is outside an operational design domain (ODD) set by the automated driving process of the automated driving application. Herein, ODD refers to a driving area which satisfies a driving environment condition required by the automated driving process. For example, the ODD may be set for driving areas such as: expressways and other motor vehicle-only area, an area with good driving visibility, or an area where location-related information, such as map data or GNSS information, can be properly acquired. When the low workload condition, which includes the ODD related condition, is determined to be satisfied, the container management layer 32i allocates the remainder of the hardware resource 12 to the user application 340. The remainder of the hardware resource 12 corresponds to the hardware resource 12 required for continuing the operation of automated driving application 330.

The following will describe a resource management flow executed by the control device 3 of the tenth embodiment with reference to the flowchart of FIG. 21. The resource management flow is repeatedly executed at predetermined control period of the control device 3.

In S1001, which is executed instead of S101 in the resource management flow of the first embodiment, the container management layer 32i acquires, from the automated driving container 33, the ODD information indicating whether the vehicle 2 is located in an area other than the ODD set by the automated driving process, as a result of the automated driving process.

In S1002, which is executed instead of S102 in the resource management flow of the first embodiment, the container management layer 32i determines whether the low workload condition is satisfied based on the ODD information acquired in S1001. The container management layer 32i determines whether the vehicle is outside the ODD set by the automated driving process. When an affirmative determination is made in S1002, the resource management flow proceeds to S103. When a negative determination is made in S1002, the resource management flow proceeds to S104.

The low workload condition of the tenth embodiment is determined to be satisfied when the vehicle is outside the ODD set by the automated driving process. According to this configuration, the hardware resource 12 can be allocated to the user application in response to determining that the vehicle 2 is in the manual driving mode based on the ODD information. Therefore, it is possible to effectively utilize the high-performance hardware resource 12, which is capable of executing the automated driving process, in a timely manner in response to a decrease in the workload of the automated driving application 330.

### Other Embodiments

Although multiple embodiments of the present disclosure have been described above, the present disclosure is not limited to those embodiments, and can be applied to various embodiments and combinations within a scope that does not deviate from the spirit of the present disclosure.

The dedicated computer constituting the control device 3 may include at least one of a digital circuit or an analog circuit, as a processor. The digital circuit is at least one type of, for example, an application specific integrated circuit (ASIC), a field programmable gate array (FPGA), a system on a chip (SOC), a programmable gate array (PGA), a complex programmable logic device (CPLD), and the like. Such a digital circuit may also include a memory in which a program is stored.

In a modification example of the first to tenth embodiments, partial or entire functions of the container management layer may be implemented as functions of the container engine 31.

In a modification example of the first to tenth embodiments, instead of forbidding the entire access to the hardware resource by the user application 340, a range of the hardware resource, which is forbidden to be accessed by the user application 340, can be set in a variable manner depending on a type of user application 340.

In a modification example of the first to tenth embodiments, the application designation terminal 5 may be a terminal other than the terminal mounted on the vehicle 2. For example, the application designation terminal 5 may be a terminal carried by the user, such as a smartphone or a tablet, which is capable of communicating with the control device 3 of the vehicle.

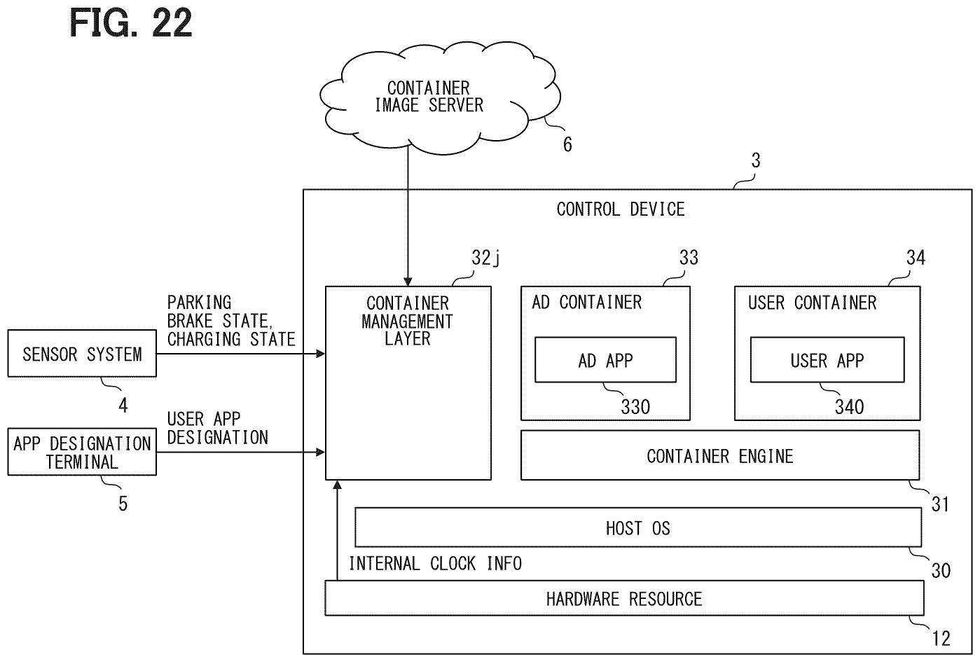

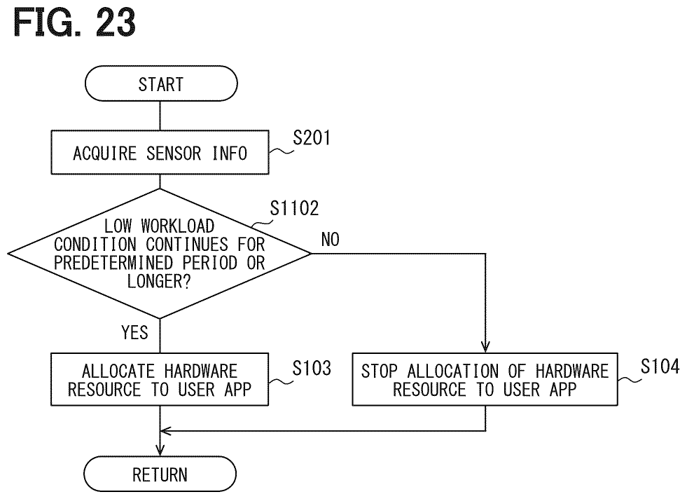

In a modification example of the second and fourth to tenth embodiments, the low workload condition may be set to be satisfied when the workload of the automated driving application 330 decreases to a set range for a predetermined period of time or longer. The following will describe this modification example in details with reference to FIG. 22 and FIG. 23 with the second embodiment as an example.

In the second embodiment, the low workload condition, in which the workload of automated driving application 330 is decreased to the set range, is determined to be satisfied when the parking brake of the vehicle 2 is activated and the vehicle 2 is in the charging state. Thus, the low workload condition in the modification of the second embodiment is determined to be satisfied when the parking brake of the vehicle 2 is activated and the charging state of vehicle 2 is continued for a predetermined period of time or longer. When the low workload condition is determined to be satisfied, the container management layer 32j allocates the remainder of the hardware resource 12 to the user application 340. The remainder of the hardware resource 12 corresponds to the hardware resource 12 required for continuing the operation of automated driving application 330.

As shown in the resource management flow in FIG. 23, in S1102, which is executed instead of S202 of the resource management flow of the second embodiment, the container management layer 32j determines whether the low workload condition is determined to be satisfied based on the sensor information acquired in S201 and internal clock information of the control device 3. When an affirmative determination is made in S1102, the resource management flow proceeds to S103. When a negative determination is made in S1102, the resource management flow proceeds to S104.

According to this modification example, the low workload condition is determined to be satisfied when the state, in which the workload is decreased to the set range, is continued for the predetermined period of time or longer. According to this configuration, the hardware resource 12 can be allocated to the user application 340 in response to determining the low workload state of the hardware resource 12 based on the continuation period of low workload state of the automated driving application 330. Therefore, it is possible to effectively utilize the high-performance hardware resource 12, which is capable of executing the automated driving process, in a timely manner in response to a decrease in the workload of the automated driving application 330.

What is claimed is:

1. A control device that controls multiple containers to share a hardware resource and a host operating system, the control device comprising:
an automated driving container executing an automated driving application on the host operating system, the automated driving application executing an automated driving process of a vehicle;
a user container executing a user application on the host operating system, the user application being designated by a user; and
a container management layer managing an allocation of the hardware resource to the automated driving application and the user application,
wherein
in response to determining that a low workload condition, in which a workload of the automated driving application decreases to a set range, being satisfied, the container management layer allocates, to the user application, a remainder of the hardware resource, which is required for continuing an execution of the automated driving application.

2. The control device according to claim 1, wherein
the container management layer determines that the low workload condition is satisfied when the vehicle is in a parking mode.

3. The control device according to claim 2, wherein
the container management layer determines that the low workload condition is satisfied when a parking brake of the vehicle is activated.

4. The control device according to claim 3, wherein
the container management layer determines that the low workload condition is satisfied when the parking brake of the vehicle is activated and the vehicle is in a charging state of electric power.

5. The control device according to claim 3, wherein
the container management layer determines that the low workload condition is satisfied when a predetermined period of time is elapsed from when the parking brake of the vehicle is activated.

6. The control device according to claim 3, wherein
the container management layer determines that the low workload condition is satisfied when the parking brake of the vehicle is activated and a start switch of the vehicle is turned off.

7. The control device according to claim 3, wherein
the container management layer determines that the low workload condition is satisfied when the parking brake of the vehicle is activated and a shift position of the vehicle is in a parking position.

8. The control device according to claim 3, wherein
the container management layer determines that the low workload condition is satisfied when the parking brake of the vehicle is activated and no pressure is applied on a brake pedal of the vehicle.

9. The control device according to claim 3, wherein
the container management layer determines that the low workload condition is satisfied when the parking brake of the vehicle is activated and a current position of the vehicle is within a parking lot.

10. The control device according to claim 3, wherein
the container management layer determines that the low workload condition is satisfied when the parking brake of the vehicle is activated and a distance between the vehicle and an unlocking unit, which unlocks the vehicle, increases to a value beyond a predetermined condition range.

11. The control device according to claim 1, wherein
the container management layer determines that the low workload condition is satisfied when the vehicle is in a manual driving mode.

12. The control device according to claim 11, wherein
the container management layer determines that the low workload condition is satisfied when an autopilot function of the vehicle, which is executed by the automated driving process, is in disabled state.

13. The control device according to claim 11, wherein
the container management layer determines that the low workload condition is satisfied when the vehicle is outside an operational design domain set by the automated driving process.

14. The control device according to claim 3, wherein
the container management layer determines that the low workload condition is satisfied when a state, in which the workload of the automated driving application decreases to the set range, is continued for a predetermined period of time or longer.

15. The control device according to claim 1, wherein
the user application is a machine learning application that updates parameters of a machine learning model related to the automated driving process.

16. The control device according to claim 1, wherein
the user application is a rental application that rents out the hardware resource to an external device.

17. The control device according to claim 1, wherein
the user application is an application that executes a pre-release application related to the vehicle for testing purpose in a virtual environment.

18. The control device according to claim 1, wherein
the container management layer prohibits the user application from accessing the automated driving container.

19. The control device according to claim 1, wherein
the container management layer prohibits the user application from accessing an area other than the hardware resource.

20. The control device according to claim 1, wherein
the container management layer stops allocating of the hardware resource to the user application when the low workload condition is no longer satisfied.

21. A resource management method, which is executed by a processor for controlling multiple containers to share a hardware resource and a host operating system, the resource management method comprising:
executing an automated driving application on the host operating system, the automated driving application executing an automated driving process of a vehicle;
executing a user application, which is designated by a user, on the host operating system;
managing an allocation of the hardware resource to the automated driving application and the user application;
determining whether a low workload condition, in which a workload of the automated driving application decreases to a set range, is satisfied; and
in response to determining the low workload condition being satisfied, allocating, to the user application, a remainder of the hardware resource, which is required for continuing an execution of the automated driving application.

22. A computer-readable non-transitory storage medium storing a resource management program, the resource management program comprising instructions to be executed by at least one processor for controlling multiple containers to share a hardware resource and a host operating system,
the instructions of the resource management program comprising:
executing an automated driving application on the host operating system, the automated driving application executing an automated driving process of a vehicle;
executing a user application, which is designated by a user, on the host operating system;
managing an allocation of the hardware resource to the automated driving application and the user application;
determining whether a low workload condition, in which a workload of the automated driving application decreases to a set range, is satisfied; and
in response to determining the low workload condition being satisfied, allocating, to the user application, a remainder of the hardware resource, which is required for continuing an execution of the automated driving application.
